(19) United States
(12) Patent Application Publication
(10) Pub. No.: US 2020/0040651 A1
(43) Pub. Date: Feb. 6, 2020

(54) ROLLER ASSEMBLY FOR SLIDING SECURITY GRILLES

(71) Applicants: Peter James Alexiadis, Toronto (CA); Shengfeng Wang, North York (CA)

(72) Inventors: Peter James Alexiadis, Toronto (CA); Shengfeng Wang, North York (CA)

(21) Appl. No.: 16/529,044

(22) Filed: Aug. 1, 2019

Related U.S. Application Data
(60) Provisional application No. 62/713,405, filed on Aug. 1, 2018.

(51) Int. Cl. E06B 9/171; E06B 9/174

(52) U.S. Cl. CPC E06B 9/171; E06B 9/18; E06B 9/174

(57) ABSTRACT

A roller assembly for supporting a sliding security grille from an above-mounted track is disclosed. The roller assembly has a shank for securing the roller assembly to a panel of the sliding security grille and a rotatable collar that couples the shank to the wheels of the roller assembly to allow the axial rotation of the wheels about the shank. The roller assembly also includes an axle support that couples the wheels to the rotatable collar, and the axle support is sized to interfere with the lips of the track to limit the axial rotation to keep the wheels aligned in the longitudinal direction of the track.

### FIELD

The present disclosure relates generally to sliding security grilles, such as those used to secure an open storefront. More particularly, the disclosure relates to sliding security grilles that are supported by rollers suspended in an above-mounted track.

### BACKGROUND

Closures of the general type reflected by the present disclosure are commonly used for retail storefronts, particularly in shopping malls, where a relatively wide opening leading into each individual shop requires a readily manipulated closure capable of providing security against unwarranted entry. These closures can have many applications, such as for food service counters, service or ticket kiosks, or security barriers in airports, for example. Articulated, rolling or folding closures are especially adaptable for such installations since these closures when in a collapsed or storage position are more easily concealed within a relatively small pocket in the side wall.

Storefront security grille systems can provide added security to a storefront, without detracting from the visual appeal. Some storefront security grille systems can include transparent material, such as a high strength transparent polycarbonate plastic, to allow the store to be viewed through the security grille. After closing the storefront security grille, store owners can leave displays and advertising in place for the benefit of the wider public.

Most security grille systems are suspended from a track mounted in the ceiling by a roller assembly to allow the grille to slide in and out of place. This roller assembly bears the weight of the grille system and is a common point of failure for maintenance calls. Another issue with prior art roller assemblies is that they would often get turned perpendicular to the track direction to prevent the sliding motion and necessitating a maintenance call. Prior art designs often do not sufficiently secure the roller assembly to the security grille for the weight of the system. In some designs, the roller assembly is attached to the security grille to allow the roller assembly to rotate which often causes mechanical wear to the roller assembly and security grille leading to mechanical failure or a security breach of the grille system. Some of the prior art designs also allow the roller assembly to move vertically with respect to the security grille which can allow a trespasser to jack up the door from the bottom to provide access. There is a need for an improved roller assembly for sliding security grilles that is not prone to mechanical failure and maintains the security of the grille system against trespassers.

U.S. Pat. No. 9,322,203 to Kleiman describes a mini slat folding door that uses a retaining pin to attach the wheels to the door. This design uses a cap and retaining pin with enough clearance to allow a significant amount of pitch, yaw and roll with the caster assembly. Placing the load of the door on a weak retaining pin is problematic for a sliding security grille as it will lead to wear and eventual failure.

U.S. Pat. No. 4,027,714 to Dixon et al. describes a dual wall accordion door where the roller assembly is supported by a threaded shank within a bore. All of the weight of the door is supported by the cap of the shank and the roller assembly does not allow for rotation about the shank. This design would not be appropriate for a sliding security grille.

U.S. Pat. No. 4,386,654 to Dever et al. describes a side folding closure where the roller assembly is supported by a hanger rod that is secured with a fastener. This places the weight of the door on the fastener which is also exposed making this unsuitable for sliding security grille systems. The hanger rods are also able to freely rotate about the door which can result in the wheels getting jammed within the track.

U.S. Pat. No. 9,976,329 to Lucci et al. describes a carriage assembly for vertically-hanging foldable barriers that includes a guide that may be disposed between two side walls of an overhead track to reduce latitudinal movement of the carriage assembly with respect to the overhead track.

### SUMMARY

According to a first aspect, a roller assembly is provided for a supporting a sliding security grille from an above-mounted track. The sliding security grille is comprised of a number of panels, and the roller assembly can be attached to every panel, alternating panels, or other variations. The roller assembly comprises a wheel (but typically two), a shank for securing the roller assembly to the panel, and a rotatable collar for coupling the shank to the wheel, the rotatably collar allows axial rotation of the wheel about the shank. This axial rotation allows the wheel to stay aligned with the longitudinal direction of the track and follow any curves. The rotatable collar can have a ball bearing, such as a thrust bearing to support the axial load from the shank.

In some aspects, a top portion of the shank can have a flange that is rotatably attached within the rotatable collar. The flange can rest upon a ball bearing to allow lower friction rotation. The rotatable collar can also provide some vertical allowance above the flange to allow limited vertical movement of the roller assembly to accommodate irregularities in the height of the floor or track. In some aspects, the shank can have a securing nut to lock the height of the shank with respect to the panel. Preferably, the panel defines a complementary threaded aperture for receiving the shank. In other aspects, the panel can define an aperture and the threaded shank is secured with a top securing nut above the aperture and a bottom securing nut below the aperture.

In some aspects, the roller assembly can have an axle support securely attached to the rotatable collar and the axle support can be attached to an axle coupled to the wheel or a wheel on each side of the axle support. The track has a longitudinal direction and the axle support is sized to prevent rotation of the wheel axially about the shank perpendicular to the longitudinal direction of the track. The track has inward facing lips to support the one or more wheels and the lips define a gap in the longitudinal direction of the track, the axle support can act as guide, interfering with the lips to limit axial rotation of the wheels about the shank to maintain the wheels in the longitudinal direction of the track. The axle support can have a width to provide clearance within the gap between the lips and the axle support can have a length in the longitudinal direction at least longer than the width to limit axial rotation about shank.

The wheel or wheels can be coupled to the axle with a low-friction radial ball bearing and the low-friction radial ball bearing can be sealed with a dust-proof cap.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a perspective view of a sliding security grille installed in a shopping mall storefront;

FIG. 2A is a side view of an embodiment of a roller assembly threaded into a panel of a sliding security grille;

FIG. 2B is a side view of an embodiment of a roller assembly that is secured to a panel of a sliding security grille using two nuts;

FIG. 3 is a front view of the roller assembly of FIG. 2B;

FIG. 4 is a cross-sectional view of the roller assembly of FIG. 2B; and

FIG. 5 is a front view of the roller assembly of FIG. 2B installed within a supporting track.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

Although some embodiments may explicitly refer to a storefront sliding security grille system, it will be understood by those of ordinary skill in the art that teachings described herein may be applied to other sliding security grille systems that are not limited to storefronts, counters or security barriers, as described herein.

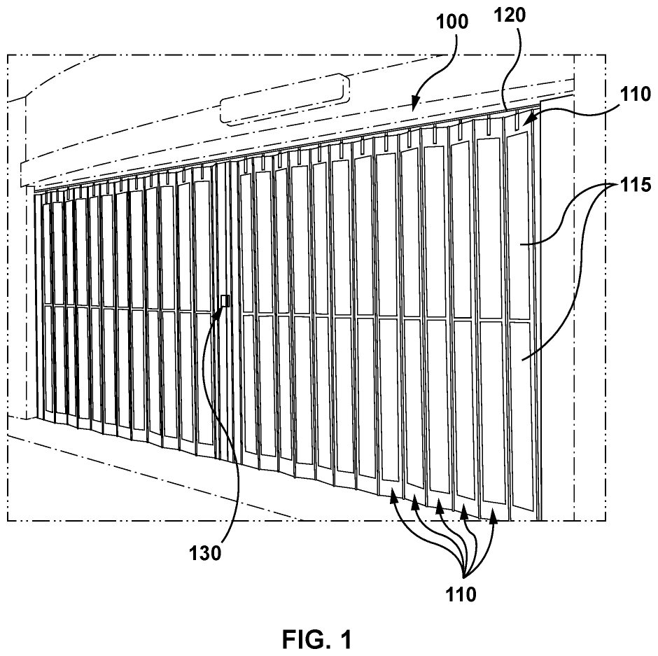

Reference is first made to FIG. 1, shown is a perspective view of a sliding security grille 100 installed within a shopping mall storefront. Similar sliding security grilles can be used for other applications, such as a food or ticket counter or a security barrier, for example. Sliding security grille 100 is comprised of panels 110 that are supported by rollers (also referred to as wheels) attached to the upper portion of panels 110. Rollers can be attached to every panel 110, every second panel 110, or some other combination depending on the weight of sliding security grille 100. In folding or articulating sliding security grilles, panels 110 are hingedly attached to adjacent panels 110 to allow sliding security grille 100 to fold upon itself for easy storage such within an access door at either side of the open storefront. Panels 110 illustrated in FIG. 1 have a transparent polycarbonate plastic insert 115 securely fixed to the panels 110 to allow visibility into the store. Panels 110 can be constructed from steel or aluminum and are often formed by extrusion. Panels 110 are preferably low cost to manufacture and light weight.

Rollers of sliding security grille 100 are supported in a ceiling mounted track 120. Track 120 is shown embedded with the bottom of the track flush with the ceiling or lintel of the passageway. In other embodiments, track 120 can be mounted on the ceiling or lintel. Some embodiments can also include a bottom-mounted track to prevent the bottom portion of the sliding security grille 100 from swaying inwards or outwards. In other embodiments, there can be lock down rods operated by a thumb-turn handle on a locking post that project out of the bottom of panel 110. Track 120 can be straight or curved to match the profile of the storefront. Curved track 120 can also be used to direct the panels to a storage area where the panels 110 can be folded upon themselves for compact storage.

Sliding security grille 100 can include a locking mechanism 130 that can allow adjacent panels to be locked together and unlocked to allow opening. In some embodiments, the locking mechanism 130 can lock a panel 110 in position with a locking rod that engages with an aperture in the ceiling, floor, or both.

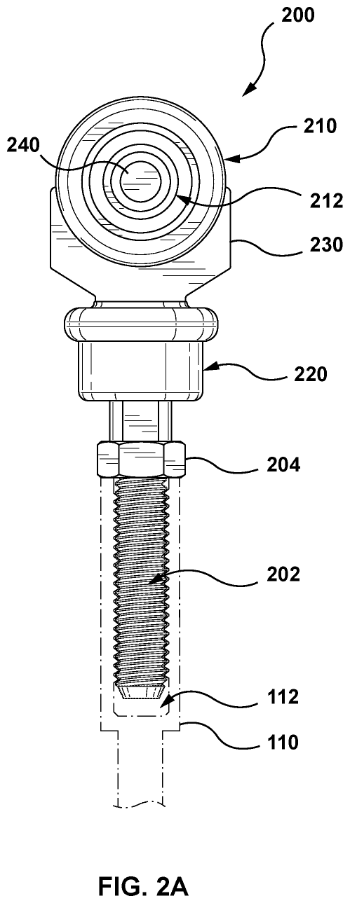

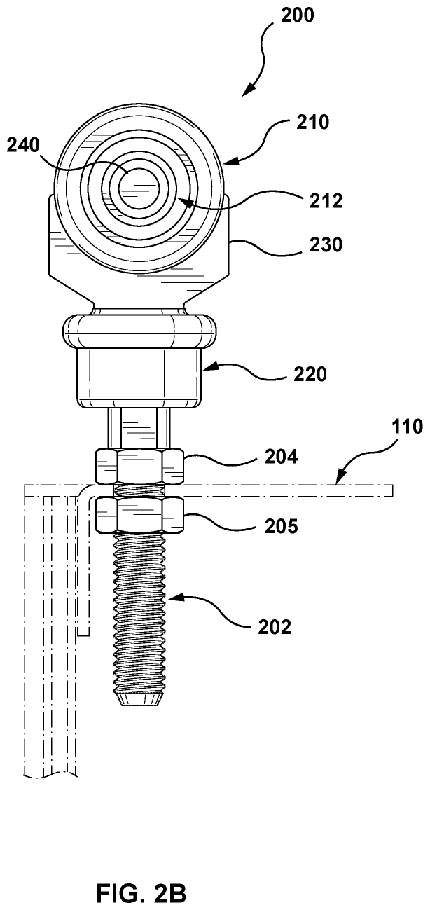

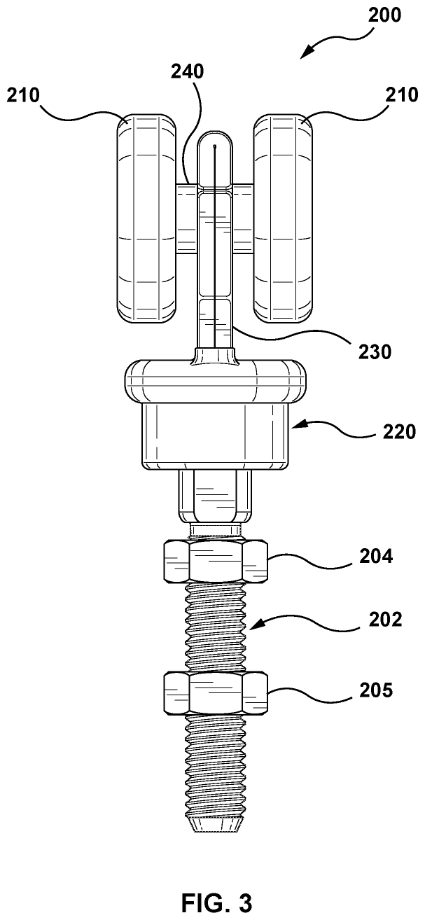

Reference is next made to FIGS. 2A, 2B, 3 and 4, which illustrate a roller assembly 200 having wheels 210 coupled to a shank 202 that can be secured to panels 110. FIG. 2A illustrates an embodiment where panel 110 provides an aperture 112 in the upper surface of panel 110 for receiving a shank 202 of roller assembly 200. Preferably, aperture 112 is a threaded bore, and shank 202 and aperture 112 have complimentary threads to allow shank 202 to be screwed into panel 110. A securing nut 204 can be used to secure shank 202 to panel 110 and secure the distance that shank 202 extends from panel 110. FIG. 2B illustrates an alternate embodiment where panel 110 provides an aperture 112 in the top surface of panel 110 and shank 202 is secured in place with a top securing nut 204 above aperture 112 and a bottom securing nut 205 below aperture 112. The embodiment of FIG. 2B can be used for a locking panel or end panel that may have a larger cross-section.

Roller assembly 200 supports the weight of sliding security grille 100 so it is important that it is firmly secured to panels 110 to prevent movement of shank 202 with respect to panel 110. Preferably, shank 202 has a sufficient diameter, sufficient length, and sufficient threads to support the weight of sliding security grille 100 and prevent any tampering with sliding security grille 100.

In prior art sliding security grilles, the roller assembly has been an area of weakness in terms of strength to support the grille, wear and maintenance, and also a security weakness. By fixedly securing shank 202 to panel 110 in a secure manner that does not allow movement of shank 202 relative to panel 110 it addresses a key area of maintenance and weakness in the security of sliding security grille 100. Prior art sliding security grilles would often allow the shank to freely rotate or move about the panel to provide rotation of the roller axially around the shank that would lead to wear and mechanical failure of the security grille. Some prior art sliding security grilles would also allow for vertical movement of the shank with respect to the panel that would allow trespassers to jack up the bottom portion of the security grille. Other prior art approaches attach the shank using a cotter pin or split pin which is often a point of failure as the pin is not strong enough to support the weight of the security grille.

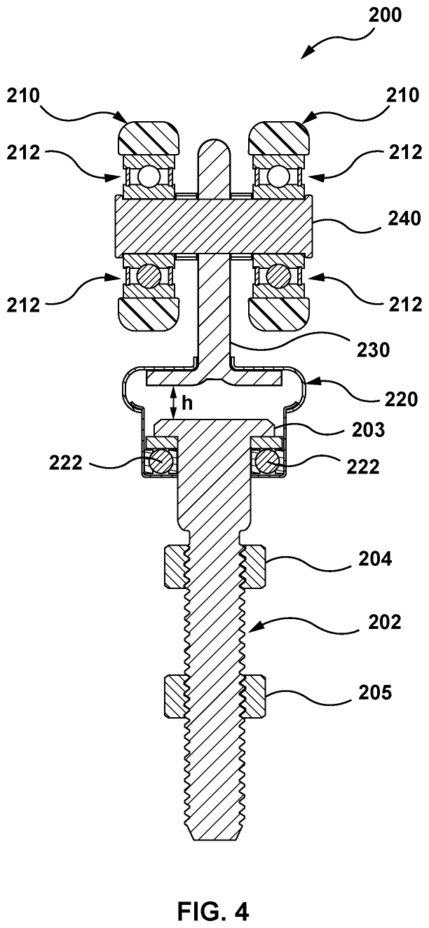

In order to allow wheels 210 to rotate axially about shank 202 a rotatable collar 220 is attached between wheels 210 and shank 202. Wheels 210 should rotate axially about shank 202 to allow sliding security grille 100 to conform to curves in track 120 and to allow sliding security grille 100 to fold upon itself for storage. Top portion of shank 202 can form a flange 203 that is secured within collar 220 and allows flange 203 to rotate within collar 220. In some embodiments, such as that illustrated in cross-sectional view of FIG. 4, flange 203 can be supported by a ball bearing 222 to provide for lower friction rotation and less wear. Ball bearing 222 is preferably a thrust ball bearing to support the axial load from the weight of sliding security grille 100. Rotatable collar 220 is preferably sealed to prevent the incursion of dust or moisture that would affect ball bearing 222.

Rotatable collar 220 can include some free vertical movement of flange 203 within collar 220 marked as vertical allowance “h” in FIG. 4. This vertical allowance can accommodate irregularities or variances in the height of track 120 or the floor. The vertical allowance is not large enough to allow sliding security grille 100 to be pried upwards to allow access underneath.

Axle support 230 supports axle 240 and is securely attached to rotatable collar 220 opposite to shank 202. Wheels 210 are rotatably mounted on axle 240 on each side of axle support 230, preferably having a low-friction radial ball bearing 212 that is sealed with a dust-proof cap to prevent the incursion of dust or moisture that would affect ball bearing 212. Some embodiments can have a single wheel 210, but having a wheel on each side of axle support 230 is preferable to balance and distribute the load from panel 110.

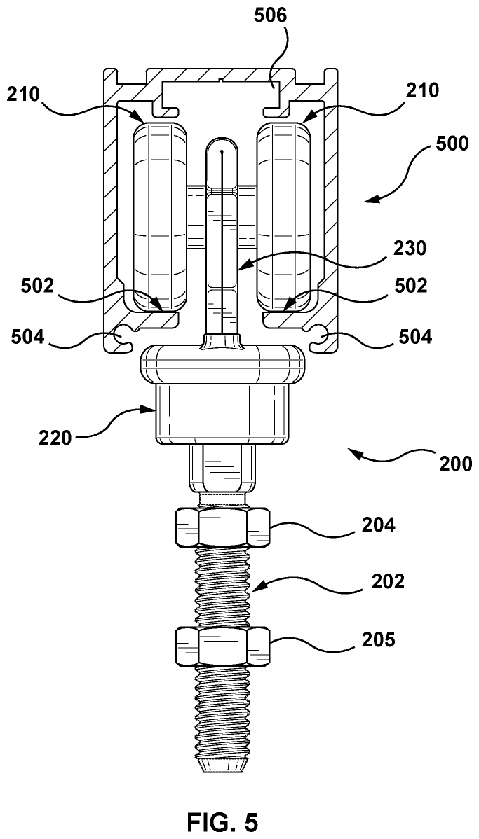

Reference is next made to FIG. 5, shown is a front view of roller assembly 200 within a cross-section of a U-shaped track 500 that has supporting lips 502 that extend inwards from the U-shaped track 500. Lips 502 support wheels 210 of roller assembly 200. Track 500 can be comprised of a number of sections that can be joined together to form a complete track, such as along a storefront, for example. Track 500 can accept alignment mechanisms, such as pins in lower alignment apertures 504 or an alignment bar in alignment slot 506, for example.

In prior art sliding security grilles, the wheels can often get turned perpendicular to the longitudinal direction of the track and will no longer roll. Axle support 230 can be sized to prevent this perpendicular axial rotation about shank 202 within the track 500. The distance between supporting lips 502 provides a narrow gap that maintains wheels 210 within track 500. Axle support 230 has a narrow front facing profile to fit within the support lip gap (i.e. the space between lips 502) and has a long side profile to prevent axial rotation of wheels 210 about shank 202 within track 500. Axle support 230 acts as a guide and will interfere with lips 502 to keep wheels aligned in the longitudinal direction of track 500. The dimensions of axle support 230 should be sized in accordance with the width of the gap between lips 502. Axle support 230 should have a width to provide sufficient clearance to move in the longitudinal direction of track 500 but have a side profile, or length, in the longitudinal direction of track 500 at least longer than the width of axle support 230 to limit axial rotation of wheels 210 about shank. In a curved track section, axle support 230 will contact one of lips 502 and cause the wheels 210 to rotate about rotatable collar 220 to maintain wheels 210 rolling in the longitudinal direction along track 500.

Rotatable collar 220 also serves as stop when upward force is applied to the sliding security grille 100. Rotatable collar 220 has a width larger than the gap between lips 502 that serves to limit upward movement of the roller assembly 200 relative to track 500. This also helps to prevent sliding security grille 100 from being pushed up from the bottom.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A roller assembly for a supporting a sliding security grille from an above-mounted track, the sliding security grille having at least one panel, the roller assembly comprising:
a wheel;
a shank for securing the roller assembly to the at least one panel; and
a rotatable collar for coupling the shank to the wheel, the rotatably collar allowing axial rotation of the wheel about the shank.

2. The roller assembly of claim 1, the rotatable collar has a ball bearing.

3. The roller assembly of claim 2, wherein the ball bearing is a thrust bearing to support axial load from the shank.

4. The roller assembly of claim 2, wherein a top portion of the shank has a flange that is rotatably attached within collar.

5. The roller assembly of claim 4, wherein the flange rests upon the ball bearing.

6. The roller assembly of claim 5, wherein the rotatable collar provides a vertical allowance above the flange to allow limited vertical movement of the roller assembly.

7. The roller assembly of claim 1, wherein the shank is threaded to secure the shank to the at least one panel.

8. The roller assembly of claim 6, wherein the shank has a securing nut.

9. The roller assembly of claim 1 further comprising an axle support securely attached to the rotatable collar, the axle support having an axle coupled to the wheel.

10. The roller assembly of claim 9, wherein the track has a longitudinal direction and the axle support is sized to prevent rotation of the wheel axially about the shank perpendicular to the longitudinal direction of the track.

11. The roller assembly of claim 10, wherein the track has inward facing lips to support one or more wheels, the lips defining a gap in the longitudinal direction of the track, the axle support interfering with the lips to maintain the wheel in the longitudinal direction of the track.

12. The roller assembly of claim 11, wherein the axle support having a width to provide clearance within the gap and the axle support having a length in the longitudinal direction at least longer than the width to limit axial rotation about shank.

13. The roller assembly of claim 9, wherein the wheel is coupled to the axle with a low-friction radial ball bearing.

14. The roller assembly of claim 13, wherein the low-friction radial ball bearing is sealed with a dust-proof cap.
